(19) United States
(12) Patent Application Publication
(10) Pub. No.: US 2006/0158978 A1
(43) Pub. Date: Jul. 20, 2006

(54) Optical disk apparatus

(75) Inventor: Masaki Matsumoto, Daito-shi (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito-shi (JP)

(21) Appl. No.: 11/328,056

(22) Filed: Jan. 10, 2006

(30) Foreign Application Priority Data
Jan. 14, 2005 (JP) 2005-7431

(51) Int. Cl. G11B 7/00

(52) U.S. Cl. 369/44.41; 369/44.13; 369/44.27

(57) ABSTRACT

There is provided an optical disk apparatus having a function of speedily calculating the amount of optical axis misalignment of an optical pickup to allow a wobble signal to be obtained early when initially spinning up an optical disk. Servo control means 27 turns the focusing servo on while turns the tracking servo off when initially spinning up an optical disk. In this state, optical axis misalignment calculating means 28 calculates the amount of optical axis misalignment X by a calculation formula X=[(A+B)−(C+D)]/(A+B+C+D) [%]. Subsequently, offset adding means 29 adds an offset value according to the amount of optical axis misalignment X to a tracking drive voltage after turning the tracking servo on. Then, wobble detecting means 30 detects a wobble signal by (A+B)−(C+D) after the offset value is added.

### BACKGROUND OF THE INVENTION

1. Field of the Invention

The present invention relates to an optical disk apparatus for reproducing or recording/reproducing information onto/from an optical disk, and more particularly to detection processing of a wobble signal that indicates a wobble of a track groove inscribed on an optical disk.

2. Description of the Prior Art

In conventional optical disk apparatuses, in order to make a laser beam emitted from an optical pickup follow the track surface of an optical disk, there are performed tracking servo control, in which an objective lens in the optical pickup is moved slightly horizontally (radially) with respect to the optical disk, and focusing servo control, in which the objective lens is moved slightly vertically with respect to the optical disk. The optical pickup has a tracking actuator for moving the objective lens slightly horizontally with respect to the optical disk with an application of a tracking drive voltage and a focusing actuator for moving the objective lens slightly vertically with respect to the optical disk with an application of a focusing drive voltage.

Meanwhile, in optical disk apparatuses, it is determined if a loaded optical disk is a recordable/reproducible one (DVD-R or DVD+R), which can be used also for recording by a user, or a reproducible one (DVD-ROM), which can be used only for reproducing by a user, and there is performed processing based on the type of the optical disk to reproduce information from the optical disk.

In conventional optical disk apparatuses, in order to thus determine the type of an optical disk, an offset value is added, stepwise for example, to a tracking drive voltage applied to the tracking actuator in the optical pickup with the focusing servo on while the tracking servo off. After several times of adding the offset value to the tracking actuator, if a wobble signal (having a predetermined frequency) that indicates a wobble of a track groove inscribed on the optical disk is detected, it is recognized that there is a wobble signal to determine that the loaded optical disk is a recordable/reproducible one (DVD-R or DVD+R).

Also, after several times of adding the offset value to the tracking actuator, if no wobble signal (having a predetermined frequency) is detected, it is recognized that there is no wobble signal to determine that the loaded optical disk is a reproducible one (DVD-ROM). For example, since the frequency of a wobble signal for a DVD-R is 140 KHz at a single speed, it is found that the loaded optical disk is a DVD-R.

On the other hand, since a wobble signal for a DVD-ROM has a random frequency, which is the same as the case where there is no wobble signal, it is found that the loaded optical disk is a DVD-ROM. That is, in the case of a DVD-ROM being loaded, since no wobble signal will be detected after any time of adding an offset value stepwise to a tracking drive voltage, it is found that the loaded optical disk is a DVD-ROM.

However, in such conventional optical disk apparatuses, an offset value is changed stepwise to be added to a tracking drive voltage to detect a wobble signal as mentioned above, the processing of changing the offset value stepwise to be added to the tracking drive voltage being required to be performed multiple times until a wobble signal is detected, which takes a long time to determine an optical disk, resulting in a problem of time delay before reproduction.

It is noted that the prior art described in Japanese Patent Laid-Open Publication No. 2000-242952 is adapted to correct an inclination of the optical axis of an optical head (optical pickup) using a wobble signal, but not to detect the amount of optical axis misalignment of an optical pickup in the tracking direction using a wobble signal. Also, the prior art described in Japanese Patent Laid-Open Publication No. Hei 11-25493 is adapted to correct an inclination of an optical pickup using a distance sensor, but not to disclose detection of a wobble signal.

### SUMMARY OF THE INVENTION

The present invention has been made to solve the above-described problems, and an object thereof is to provide an optical disk apparatus having a function of speedily calculating the amount of optical axis misalignment of an optical pickup to allow a wobble signal to be obtained early when initially spinning up an optical disk.

In order to achieve the foregoing object, the invention according to claim 1 provides an optical disk apparatus including an optical pickup to reproduce or record/reproduce information onto/from an optical disk, the optical pickup being adapted to collect emitted light from a luminous element for emitting a laser beam on the optical disk through an objective lens to form a small light spot and adapted to make reflected light from the optical disk incident into a light detector divided into four regions through the objective lens to obtain a readout signal, the apparatus comprising a system controller having: servo control means for turning the focusing servo for the objective lens in the optical pickup on while turning the tracking servo therefor off when initially spinning up the optical disk; optical axis misalignment calculating means for calculating the amount of optical axis misalignment X of the objective lens in the optical pickup in the tracking direction by a calculation formula X=[(A+B)−(C+D)]/(A+B+C+D) [%] with the focusing servo on while the tracking servo off, where A, B, C, and D represent the amount of light received at light detecting elements corresponding to the respective four divided regions in the light detector; offset adding means for adding an offset value according to the amount of optical axis misalignment X to a tracking drive voltage after turning the tracking servo on; and wobble detecting means for detecting a wobble signal by (A+B)−(C+D) after the offset value is added.

In the arrangement above, the servo control means turns the focusing servo on while turns the tracking servo off when initially spinning up the optical disk. In this state, the optical axis misalignment calculating means calculates the amount of optical axis misalignment X by a calculation formula X=[(A+B)−(C+D)]/(A+B+C+D) [%]. Subsequently, the offset adding means adds an offset value according to the amount of optical axis misalignment X to a tracking drive voltage after turning the tracking servo on. Then, the wobble detecting means detects a wobble signal by (A+B)−(C+D) after the offset value is added.

In accordance with the arrangement above, since the amount of optical axis misalignment of the optical pickup is calculated by a calculation formula, it is possible to find the amount of optical axis misalignment speedily and thereby to obtain a wobble signal early when initially spinning up the optical disk, whereby the type of the loaded optical disk can be determined speedily, which therefore makes it possible to shorten the time before reproduction, resulting in an improvement in user-friendliness.

The invention according to claim 2 provides an optical disk apparatus including an optical pickup to reproduce or record/reproduce information onto/from an optical disk, the optical pickup being adapted to collect emitted light from a luminous element for emitting a laser beam on the optical disk through an objective lens to form a small light spot and adapted to make reflected light from the optical disk incident into a light detector through the objective lens to obtain a readout signal, the apparatus comprising a system controller having: servo control means for turning the focusing servo for the objective lens in the optical pickup on while turning the tracking servo therefor off when initially spinning up the optical disk; optical axis misalignment calculating means for calculating the amount of optical axis misalignment of the objective lens in the optical pickup in the tracking direction by a calculation formula with the focusing servo on while the tracking servo off; offset adding means for adding an offset value according to the amount of optical axis misalignment to a tracking drive voltage after turning the tracking servo on; and wobble detecting means for detecting a wobble signal after the offset value is added to the tracking drive voltage.

In the arrangement above, the servo control means turns the focusing servo on while turns the tracking servo off when initially spinning up the optical disk. In this state, the optical axis misalignment calculating means calculates the amount of optical axis misalignment of the objective lens in the optical pickup in the tracking direction. Subsequently, the offset adding means adds an offset value according to the amount of optical axis misalignment to a tracking drive voltage after turning the tracking servo on. Then, the wobble detecting means detects a wobble signal after the offset value is added to the tracking drive voltage.

In accordance with the arrangement above, since the amount of optical axis misalignment of the optical pickup is calculated by a calculation formula, it is possible to find the amount of optical axis misalignment speedily and thereby to obtain a wobble signal early when initially spinning up the optical disk, whereby the type of the loaded optical disk can be determined speedily, which therefore makes it possible to shorten the time before reproduction, resulting in an improvement in user-friendliness.

In the invention according to claim 3, the invention according to claim 2 is arranged in such a manner that the light detector is composed of four light detecting elements that correspond, respectively, to four divided light receiving regions; the optical axis misalignment calculating means is adapted to calculate the amount of optical axis misalignment X of the objective lens in the optical pickup in the tracking direction by a calculation formula X=[(A+B)−(C+D)]/(A+B+C+D) [%] with the focusing servo on while the tracking servo off, where A, B, C, and D represent the amount of light received at the light detecting elements corresponding to the respective four divided regions in the light detector; and the wobble detecting means is adapted to detect a wobble signal by (A+B)−(C+D) after an offset value according to the amount of optical axis misalignment X is added to a tracking drive voltage.

Accordingly, if there is provided a light detector having four light detecting elements that correspond, respectively, to four divided light receiving regions, it is possible to calculate the amount of optical axis misalignment X speedily by a calculation formula X=[(A+B)−(C+D)]/(A+B+C+D) [%], and therefore to detect a wobble signal by (A+B)−(C+D) after an offset value according to the amount of optical axis misalignment X is added to a tracking drive voltage. Thus obtained wobble signal shows a high accuracy with an extremely small amount of optical axis misalignment of the optical pickup in the tracking direction and thereby a high S/N ratio.

As mentioned above, in accordance with the present invention, in an optical disk apparatus including an optical pickup to reproduce or record/reproduce information onto/from an optical disk, the optical pickup being adapted to collect emitted light from a luminous element for emitting a laser beam on the optical disk through an objective lens to form a small light spot and adapted to make reflected light from the optical disk incident into a light detector divided into four regions through the objective lens to obtain a readout signal, there is provided a system controller having: servo control means for turning the focusing servo for the objective lens in the optical pickup on while turning the tracking servo therefor off when initially spinning up the optical disk; optical axis misalignment calculating means for calculating the amount of optical axis misalignment X of the objective lens in the optical pickup in the tracking direction by a calculation formula X=[(A+B)−(C+D)]/(A+B+C+D) [%] with the focusing servo on while the tracking servo off, where A, B, C, and D represent the amount of light received at light detecting elements corresponding to the respective four divided regions in the light detector; offset adding means for adding an offset value according to the amount of optical axis misalignment X to a tracking drive voltage after turning the tracking servo on; and wobble detecting means for detecting a wobble signal by (A+B)−(C+D) after the offset value is added, whereby since the amount of optical axis misalignment of the optical pickup can be calculated by a calculation formula, it is possible to find the amount of optical axis misalignment speedily and thereby to obtain a wobble signal early when initially spinning up the optical disk, whereby the type of the loaded optical disk can be determined speedily, which therefore makes it possible to shorten the time before reproduction, resulting in an improvement in user-friendliness.

Also, in accordance with the present invention, in an optical disk apparatus including an optical pickup to reproduce or record/reproduce information onto/from an optical disk, the optical pickup being adapted to collect emitted light from a luminous element for emitting a laser beam on the optical disk through an objective lens to form a small light spot and adapted to make reflected light from the optical disk incident into a light detector through the objective lens to obtain a readout signal, there is provided a system controller having: servo control means for turning the focusing servo for the objective lens in the optical pickup on while turning the tracking servo therefor off when initially spinning up the optical disk; optical axis misalignment calculating means for calculating the amount of optical axis misalignment of the objective lens in the optical pickup in the tracking direction by a calculation formula with the focusing servo on while the tracking servo off; offset adding means for adding an offset value according to the amount of optical axis misalignment to a tracking drive voltage after turning the tracking servo on; and wobble detecting means for detecting a wobble signal after the offset value is added to the tracking drive voltage, whereby since the amount of optical axis misalignment of the optical pickup can be calculated by a calculation formula, it is possible to find the amount of optical axis misalignment speedily and thereby to obtain a wobble signal early when initially spinning up the optical disk, whereby the type of the loaded optical disk can be determined speedily, which therefore makes it possible to shorten the time before reproduction, resulting in an improvement in user-friendliness.

### BRIEF DESCRIPTION OF THE DRAWINGS

FIG. 1 is a block diagram showing the arrangement of an optical disk apparatus according to an embodiment of the present invention;

FIG. 2 is a simplified block diagram illustrating an arrangement that characterizes the embodiment;

FIG. 3 is a signal waveform diagram showing signals each including an RF signal and a TE signal that are obtained by converting light received at each light detecting element into an electrical signal in the embodiment;

FIG. 4 is a view showing wobbles of track grooves inscribed on an optical disk in the embodiment; and

FIG. 5 is a flow chart illustrating detection processing of a wobble signal and disk determination processing in the embodiment.

### DESCRIPTION OF THE PREFERRED EMBODIMENTS

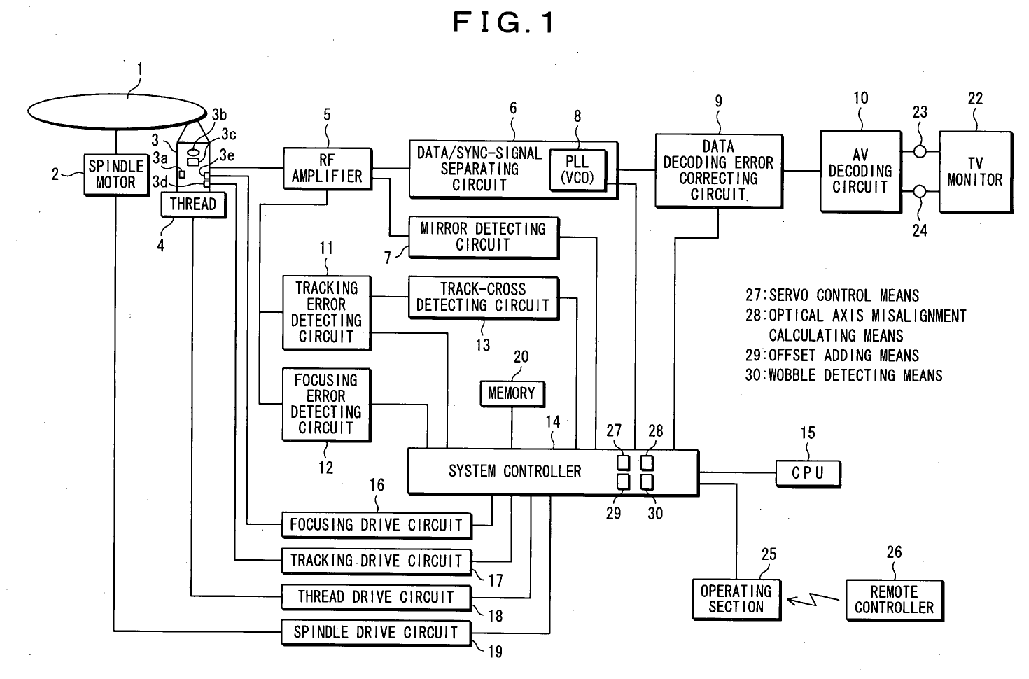

An embodiment of the present invention will hereinafter be described with reference to the accompanying drawings. FIG. 1 is a block diagram showing the arrangement of an optical disk apparatus according to the embodiment of the present invention.

In FIG. 1, the optical disk apparatus comprises an optical pickup 3 adapted to collect emitted light from a luminous element 3a for emitting a laser beam on an optical disk 1 through an objective lens 3b to form a small light spot and adapted to make reflected light from the optical disk 1 incident into a light detector 3c divided into four regions through the objective lens 3b to obtain a readout signal. Also, the optical pickup 3 has a tracking actuator 3d for moving the objective lens 3b slightly horizontally (radially) with respect to the optical disk 1 to perform tracking servo and a focusing actuator 3e for moving the objective lens 3b slightly vertically with respect to the optical disk 1 to perform focusing servo.

The optical disk apparatus comprises: a spindle motor 2 for rotating the optical disk 1; a spindle drive circuit 19 for driving the spindle motor 2; a tracking drive circuit 17 for driving the tracking actuator 3d; a focusing drive circuit 16 for driving the focusing actuator 3e; and a thread 4 for moving the optical pickup 3 in the radial direction of the optical disk 1; and a thread drive circuit 18 for driving the thread 4.

The optical disk apparatus also comprises: an RF amplifier 5 for amplifying an RF signal from the optical disk 1 when reproducing the optical disk 1; a data/sync-signal separating circuit 6 comprising a PLL (Phase Locked Loop) 8 that includes a VCO (Voltage Controlled Oscillator) to receive an RF signal from the RF amplifier 5 and to separate data and sync-signals; a data decoding error correcting circuit 9 for receiving and decoding data separated in the data/sync-signal separating circuit 6 to make an error check, and if there is a data error, for correcting the error to output correct data; and an AV decoding circuit 10 for receiving and decoding the correct data from the data decoding error correcting circuit 9 to supply a video signal and an audio signal to, for example, a TV monitor 22 through a video output terminal 23 and an audio output terminal 24 respectively.

The optical disk apparatus further comprises: a mirror detecting circuit 7 for detecting a mirror signal included in an RF signal from the RF amplifier 5 and indicating a mirror plane with no track provided on the optical disk 1 and for counting the number of mirror planes; a tracking error detecting circuit 11 for detecting a tracking error signal included in an RF signal from the optical pickup 3 through the RF amplifier 5; a focusing error detecting circuit 12 for detecting a focusing error signal included in an RF signal from the optical pickup 3 through the RF amplifier 5; a track-cross detecting circuit 13 for detecting a track cross based on a tracking error signal from the tracking error detecting circuit 11 to output a track pulse; and a memory 20 for storing data required for processing in a system controller 14.

The optical disk apparatus still further comprises an operating section 25 having a plurality of keys that are provided on the front face, etc. of the main body to perform, for example, an ON/OFF operation for the power supply and various operations regarding reproduction. The operating section 25 comprises light receiving means (not shown in the figure) for receiving an optical signal that indicates an operating command from a remote controller 26, the light receiving means being adapted to convert the optical signal into an electrical signal to input a command signal in the system controller 14. The remote controller 26 has a plurality of keys (not shown in the figure) for performing, for example, an ON/OFF operation for the power supply and various operations regarding reproduction.

The optical disk apparatus also comprises the system controller 14 for controlling the foregoing components following a CPU 15 adapted to perform processing for the entire apparatus. The system controller 14 is adapted to perform: focusing servo control for the optical pickup 3 based on a focusing error signal included in an RF signal from the optical pickup 3; tracking servo control for the optical pickup 3 based on a tracking error signal included in an RF signal from the optical pickup 3; movement control for the optical pickup 3 in the radial direction of the optical disk 1 by driving the thread 4 through the thread drive circuit 18 so that the reproduction position on the optical disk 1 is decided in accordance with a reproduction indicating signal from the operating section 25 or the remote controller 26; and rotation control for the spindle motor 2 through the spindle drive circuit 19 based on an operation signal from the operating section 25 or the remote controller 26.

The system controller 14 further has: servo control means 27 for turning the focusing servo for the objective lens 3b in the optical pickup 3 on while turning the tracking servo therefor off when initially spinning up the optical disk 1; optical axis misalignment calculating means 28 for calculating the amount of optical axis misalignment X of the objective lens 3b in the optical pickup 3 in the tracking direction by a calculation formula X=[(A+B)−(C+D)]/(A+B+C+D) [%] with the focusing servo on while the tracking servo off, where A, B, C, and D represent the amount of light received at light detecting elements “a”, “b”, “c”, and “d” corresponding to the respective four divided regions in the light detector 3c in the optical pickup 3; offset adding means 29 for adding an offset value according to the amount of optical axis misalignment X to a tracking drive voltage after turning the tracking servo on; and wobble detecting means 30 for detecting a wobble signal by (A+B)−(C+D) after the offset value is added to the tracking drive voltage.

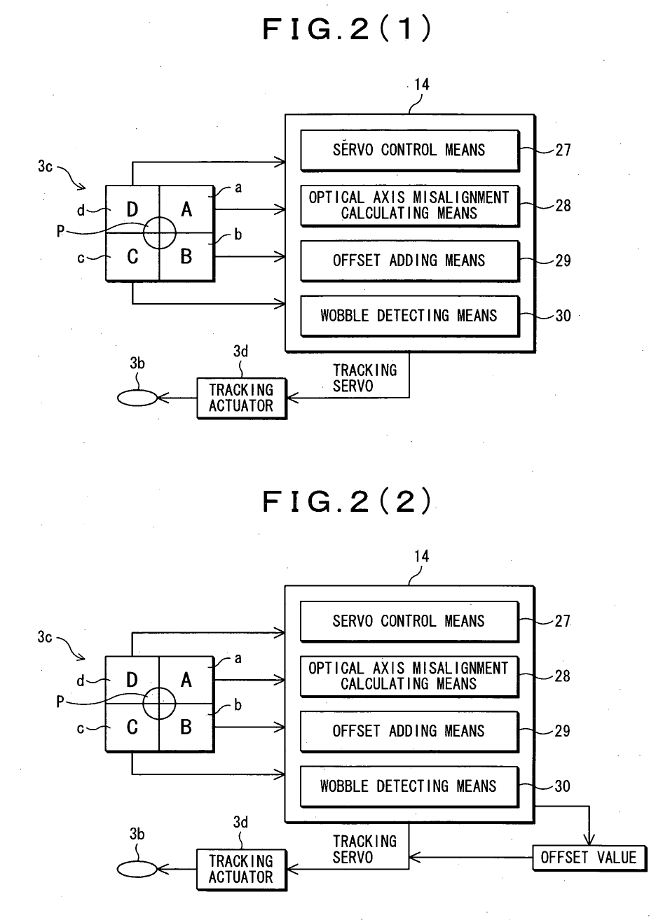

FIG. 2 is a simplified block diagram illustrating an arrangement that characterizes the present embodiment. In FIG. 2, the numeral 3c indicates the light detector 3c divided into four regions and provided in the optical pickup 3 (refer to FIG. 1), the light detector 3c having four light detecting elements “a”, “b”, “c”, and “d”. Also, the symbol P indicates a light spot of reflected light from the optical disk 1 when the optical axis of the optical pickup 3 is misaligned with respect to the track surface of the optical disk 1, where A, B, C, and D not only indicate light receiving surfaces of the respective light detecting elements “a”, “b”, “c”, and “d” adapted to receive the light spot P, but also represent the amount of light received in a calculation formula for calculating the amount of optical axis misalignment. Since the other components have been described in FIG. 1, the descriptions thereof will be omitted.

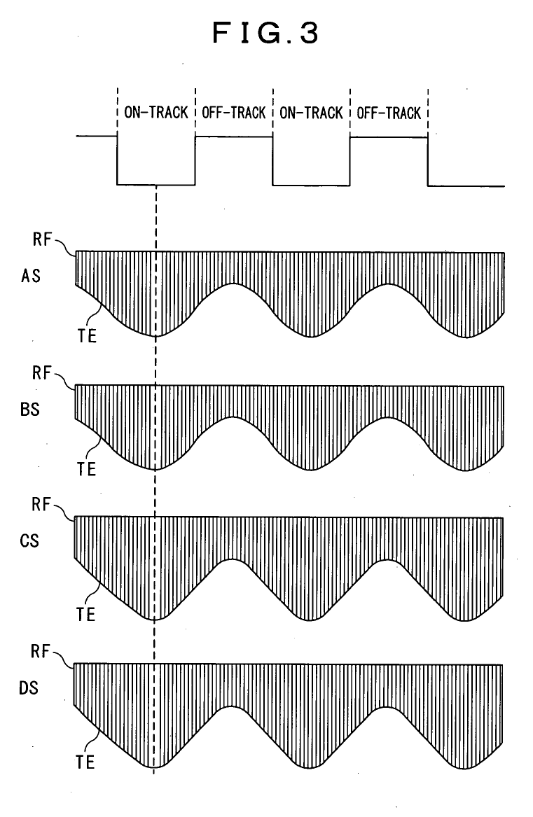

FIG. 3 is a signal waveform diagram showing signals each including an RF signal and a TE (Tracking Error) signal that are obtained by converting light received at the light detecting elements “a”, “b”, “c”, and “d” into an electrical signal in the present embodiment.

In FIG. 3, AS indicates a signal including an RF signal and a TE signal that are obtained by converting the amount of light A received at the light detecting element “a” in the light detector 3c into an electrical signal. BS indicates a signal including an RF signal and a TE signal that are obtained by converting the amount of light B received at the light detecting element “b” in the light detector 3c into an electrical signal. CS indicates a signal including an RF signal and a TE signal that are obtained by converting the amount of light C received at the light detecting element “c” in the light detector 3c into an electrical signal. DS indicates a signal including an RF signal and a TE signal that are obtained by converting the amount of light D received at the light detecting element “d” in the light detector 3c into an electrical signal. As shown in FIG. 3, the signals AS, BS, CS, and DS each have a large amplitude in an on-track state where the laser beam is on a track, while have a small amplitude in an off-track state where the laser beam is not on a track. Particularly, if the laser beam is on the center of a track, the amplitude increases in accordance with the existence of a pit.

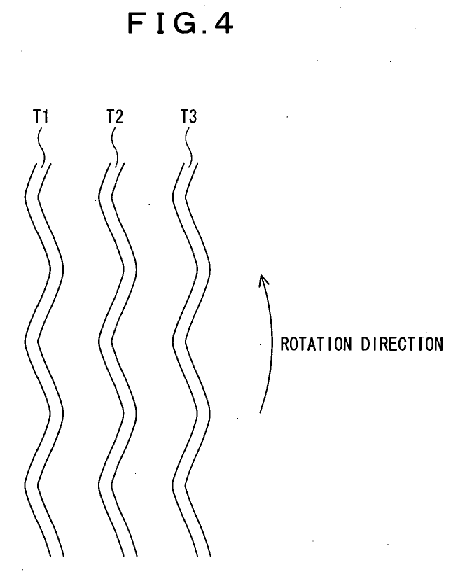

FIG. 4 is a view showing wobbles of track grooves inscribed on an optical disk in the present embodiment. In FIG. 4, the symbols T1, T2, and T3 indicate track grooves.

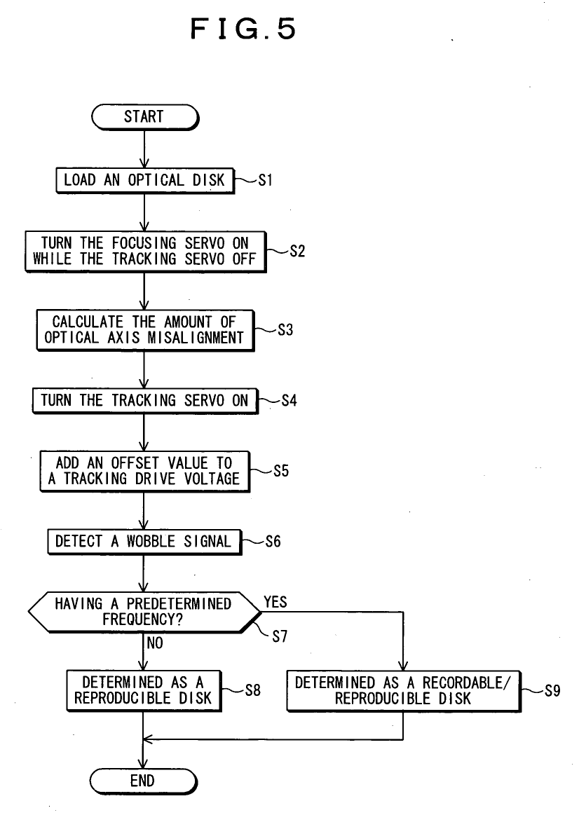

FIG. 5 is a flow chart illustrating detection processing of a wobble signal and disk determination processing in the present embodiment. Detection processing of a wobble signal and disk determination processing will be described with reference to the flow chart. It is noted that even if a tracking error signal may be detected by any of a DPP (Differential Push Pull) method, a three-beam method, or a push-pull method, these methods have nothing to do with the detection of a wobble signal, which allows the foregoing calculation formula to be applied to calculate the amount of optical axis misalignment X until a wobble signal is detected.

When an optical disk 1 desired to be reproduced by the optical disk apparatus is loaded (step S1), the servo control means 27 in the system controller 14 turns the focusing servo for the objective lens 3b in the optical pickup 3 on while turns the tracking servo therefor off when initially spinning up the optical disk 1 (step S2). Thus, the focusing actuator 3e in the optical pickup 3 is provided with a focusing drive voltage from the focusing drive circuit 16, so that focusing control for the objective lens 3b is performed.

Meanwhile, the tracking actuator 3d in the optical pickup 3 is not provided with a tracking drive voltage, which keeps the tracking servo off. If the tracking servo is in an off state, a laser beam applied from the optical pickup 3 to the optical disk 1 runs across track grooves on the optical disk 1 due to disk eccentricity with a rotation of the optical disk 1. Using this mechanism, since the laser beam runs across a plurality of grooves in accordance with the amount of eccentricity to return to the original position with, for example, a single rotation of the disk, the amplitude (peak-to-peak) of such signals AS, BS, CS, and DS as shown in FIG. 3 varies significantly, which makes it possible to detect the amount of optical axis misalignment X with accuracy.

Next, the optical axis misalignment calculating means 28 in the system controller 14 calculates the amount of optical axis misalignment X of the objective lens 3b in the optical pickup 3 in the tracking direction by a calculation formula X=[(A+B)−(C+D)]/(A+B+C+D) [%] with the focusing servo on while the tracking servo off, where A, B, C, and D represent the amount of light received at the light detecting elements “a”, “b”, “c”, and “d” corresponding to the respective four divided regions in the light detector 3c in the optical pickup 3 (step S3).

The amount of light received A, B, C, and D can be obtained with, for example, a single rotation of the optical disk 1, by measuring the amplitude (peak-to-peak) of such signals AS, BS, CS, and DS as shown in FIG. 3, for example. It is noted that in the foregoing calculation formula, the amount of light received A, B, C, and D is converted into electrical signals, and that the amount of optical axis misalignment X is calculated using these voltage values or digitally converted voltage values.

Subsequently, the offset adding means 29 in the system controller 14 turns the tracking servo on (step S4), and then adds an offset value according to the amount of optical axis misalignment X to a tracking drive voltage (step S5). This allows the tracking actuator 3d to be driven in such a manner as to correct the position of the objective lens 3b in the optical pickup 3 in the tracking direction, so that the laser beam from the objective lens 3b is applied to the center of a track on the optical disk 1.

For example, if the laser beam from the optical pickup 3 is shifted inward from the center of a track on the optical disk 1, the spot P of reflected light on the light detector 3c is positioned eccentrically toward the light receiving surfaces C and D, for example, as shown in FIG. 2 (1), and the amount of optical axis misalignment X represents, for example a negative value. Adding an offset value according to the amount of optical axis misalignment X to a tracking drive voltage allows the objective lens 3b to be moved outward with respect to the optical disk 1, and therefore the light spot P of reflected light is placed at the center of the light detector 3c as shown in FIG. 2 (2).

The offset value is thus added to the tracking drive voltage to correct the optical axis misalignment of the optical pickup 3 in the tracking direction. In this state, the wobble detecting means 30 in the system controller 14 detects a wobble signal by a push-pull method, that is, (A+B)−(C+D) (step S6). In respect to the detection of a wobble signal in this state, since the optical axis misalignment in the tracking direction has been cancelled, the wobble signal will show a high accuracy also with a high S/N ratio.

It is noted that even if the optical axis of the optical pickup 3 may be misaligned with respect to a track on the optical disk 1 in an inclined manner or the mounting position of the light detector 3c may be shifted due to adhesive material, etc., the positional correction of the objective lens 3b exhibits an effect from the viewpoint of detecting a wobble signal after calculating the amount of optical axis misalignment X with the tracking servo off if the light spot P is misaligned with respect to the light receiving surfaces A, B, C, and D of the light detector 3c.

Subsequently, disk determination processing is to be performed using thus detected wobble signal. That is, the system controller 14 determines whether or not the wobble signal has a predetermined frequency (step S7). For example, since the frequency of a wobble signal for a recordable/reproducible optical disk (DVD-R) is 140 KHz at a single speed, it is determined that the loaded optical disk 1 is a recordable/reproducible optical disk (DVD-R) if the predetermined frequency is 140 KHz (step S9).

After being determined as a recordable/reproducible optical disk (DVD-R), there is to be performed processing according to recordable/reproducible optical disks (DVD-Rs) to start reproduction. It is noted that if there is recorded content that is not allowed to be copied by copyguard protection such as CPPM (Content Protection for Prerecorded Media) on the recordable/reproducible optical disk (DVD-R), since the content is not allowed to be reproduced, there is to be performed processing to make the content part irreproducible.

On the other hand, since a wobble signal for a reproducible optical disk (DVD-ROM) has a random frequency, which is the same as the case where there is no wobble signal, it is determined that the loaded optical disk 1 is a reproducible optical disk (DVD-ROM) (step S8). After being determined as a reproducible optical disk (DVD-ROM), there is to be performed processing according to reproducible optical disks (DVD-ROMs) to start reproduction.

As described heretofore, in accordance with the present embodiment, since the amount of optical axis misalignment of the optical pickup is calculated by a calculation formula, it is possible to find the amount of optical axis misalignment speedily and thereby to obtain a wobble signal early when initially spinning up the optical disk, whereby the type of the loaded optical disk can be determined speedily, which therefore makes it possible to shorten the time before reproduction, resulting in an improvement in user-friendliness.

Although in the above-described embodiment has been described the case of detecting a wobble signal in an optical disk apparatus such as a DVD player for reproducing information recorded on an optical disk, the same applies to the case of detecting a wobble signal in an optical disk apparatus such as a DVD recorder for recording information onto an optical disk and reproducing information recorded on an optical disk.

What is claimed is:

1. An optical disk apparatus including an optical pickup to reproduce or record/reproduce information onto/from an optical disk, said optical pickup being adapted to collect emitted light from a luminous element for emitting a laser beam on said optical disk through an objective lens to form a small light spot and adapted to make reflected light from said optical disk incident into a light detector divided into four regions through said objective lens to obtain a readout signal, said apparatus comprising a system controller having:
servo control means for turning the focusing servo for said objective lens in said optical pickup on while turning the tracking servo therefor off when initially spinning up said optical disk;
optical axis misalignment calculating means for calculating the amount of optical axis misalignment X of said objective lens in said optical pickup in the tracking direction by a calculation formula X=[(A+B)−(C+D)]/(A+B+C+D) [%] with the focusing servo on while the tracking servo off, where A, B, C, and D represent the amount of light received at light detecting elements corresponding to said respective four divided regions in said light detector;
offset adding means for adding an offset value according to the amount of optical axis misalignment X to a tracking drive voltage after turning the tracking servo on; and
wobble detecting means for detecting a wobble signal by (A+B)−(C+D) after said offset value is added.

2. An optical disk apparatus including an optical pickup to reproduce or record/reproduce information onto/from an optical disk, said optical pickup being adapted to collect emitted light from a luminous element for emitting a laser beam on said optical disk through an objective lens to form a small light spot and adapted to make reflected light from said optical disk incident into a light detector through said objective lens to obtain a readout signal, said apparatus comprising a system controller having:
servo control means for turning the focusing servo for said objective lens in said optical pickup on while turning the tracking servo therefor off when initially spinning up said optical disk;
optical axis misalignment calculating means for calculating the amount of optical axis misalignment of said objective lens in said optical pickup in the tracking direction by a calculation formula with the focusing servo on while the tracking servo off;
offset adding means for adding an offset value according to the amount of optical axis misalignment to a tracking drive voltage after turning the tracking servo on; and
wobble detecting means for detecting a wobble signal after said offset value is added to said tracking drive voltage.

3. The optical disk apparatus according to claim 2, wherein
said light detector is composed of four light detecting elements that correspond, respectively, to four divided light receiving regions;
said optical axis misalignment calculating means is adapted to calculate the amount of optical axis misalignment X of said objective lens in said optical pickup in the tracking direction by a calculation formula X=[(A+B)−(C+D)]/(A+B+C+D) [%] with the focusing servo on while the tracking servo off, where A, B, C, and D represent the amount of light received at said light detecting elements corresponding to said respective four divided regions in said light detector; and
said wobble detecting means is adapted to detect a wobble signal by (A+B)−(C+D) after an offset value according to the amount of optical axis misalignment X is added to a tracking drive voltage.
